(19) United States
(12) Patent Application Publication
(10) Pub. No.: US 2009/0115669 A1
(43) Pub. Date: May 7, 2009

(54) WIRELESS COMMUNICATION DEVICE

(75) Inventor: Mei-Lan CHENG, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/140,552

(22) Filed: Jun. 17, 2008

(30) Foreign Application Priority Data
Nov. 2, 2007 (TW) 096141539

(51) Int. Cl. H01Q 1/40; H01Q 1/24

(52) U.S. Cl. 343/702; 343/873

(57) ABSTRACT

A wireless communication device includes a housing and an antenna unit. The antenna unit is disposed on the outer or inner surface of the housing. A protective layer is optionally disposed to cover the outer surface of the antenna unit and, even more, at least a portion of the housing. Thus, the antenna unit separated from the circuit board does not occupy the layout region of the circuit board, so that the layout region of the circuit board can be used for other purposes. Moreover, the antenna unit formed on the housing can enhance the performance of the wireless communication device for transceiving signals.

### CROSS REFERENCE TO RELATED APPLICATIONS

This Non-provisional application claims priority under 35 U.S.C. §119(a) on Patent Application No(s). 096141539 filed in Taiwan, Republic of China on Nov. 2, 2007, the entire contents of which are hereby incorporated by reference.

### BACKGROUND OF THE INVENTION

1. Field of Invention

The invention relates to a wireless communication device and, in particular, to a wireless communication device having metallic painted antenna.

2. Related Art

The wireless communication technology is continuously progressed so that various types of wireless communication electronic devices are developed. The antenna is miniaturized for achieving prettier and lighter portable wireless communication device, such as the Bluetooth earpiece, Zigbee or WiFi wireless network. However, the miniaturization of the antenna would affect the efficiency of the device apparently.

FIG. 1A is a partial cross-sectional view of a wireless communication electronic device that shows the layout of a conventional antenna 12. As shown in FIG. 1A, the antenna 12 is directly formed on a circuit board 10 by coating, electroplating, evaporating or sputtering. The circuit board 10 is disposed beneath a housing 18 of the wireless communication electronic device. The antenna 12 and the circuit board 10 can be electrically connected to -each other by direct contact or via additional conductive wires. However, the circuit architecture mentioned above is implemented by forming the antenna 12 onto the circuit board 10 directly. That is, a clearance area on the circuit board 10 has to be preserved according to the size and operation power of the antenna 12. Consequently, the available layout area of the circuit board 10 is greatly constricted.

Alternatively, another conventional antenna of a wireless communication electronic device is shown in FIG. 1B. As shown in FIG. 1B, the antenna is a planar inverted-F antenna 14, which has an inverted-F shape apparently. The planar inverted-F antenna (PIFA) 14 is disposed on and electrically connected to a circuit board 10. A housing 18 of the wireless communication electrical device is disposed above the planar inverted-F antenna 14.

FIG. 1C is a partial cross-sectional view of another wireless communication electronic device that shows still another conventional antenna 16. As shown in FIG. 1C, the antenna 16 is a flexible antenna disposed inside a housing 18. In practice, a 14 mm*6 mm clearance area has to be preserved on a circuit board 10 for the flexible antenna 16 with a size of 11.9 mm*5 mm. Nevertheless, the clearance area requirement is conflicted with the philosophy of minimization and low-cost.

### SUMMARY OF THE INVENTION

In view of the foregoing, the invention is to provide a wireless communication device that has an antenna unit disposed on the outer surface of a housing. As a result, the antenna unit of the invention is not disposed on the circuit board so that more layout region of the circuit board can be released for other purposes. Moreover, the antenna unit formed on the housing can enhance the signal transmission performance of the wireless communication device.

To achieve the above, the invention discloses a wireless communication device including a housing, an antenna unit and a protective layer. The antenna unit is disposed on the outer surface of the housing. The protective layer covers the antenna unit and at least a portion of the housing as well. Alternatively, the antenna unit is disposed on the inner surface of the housing, and the protective layer covers the antenna unit selectively.

As mentioned above, since the antenna is disposed on the housing instead of the circuit board, the layout region used on the circuit board can be minimized. Thus, the wireless communication device can be minimized, or more additional electronic elements can be configured in the wireless communication device so as to improve the performance thereof. Comparing to the prior art, the configuration as well as the manufacturing processes of the wireless communication device remain as usual but the performance of transmitting signals can be enhanced via disposing the antenna unit on the housing. Furthermore, the manufacturing processes and the assemble procedures can be simplified so that the manufacturing time and cost can be reduced.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1A is a partial cross-sectional view of a wireless communication electronic device showing a conventional antenna disposed on a circuit board;

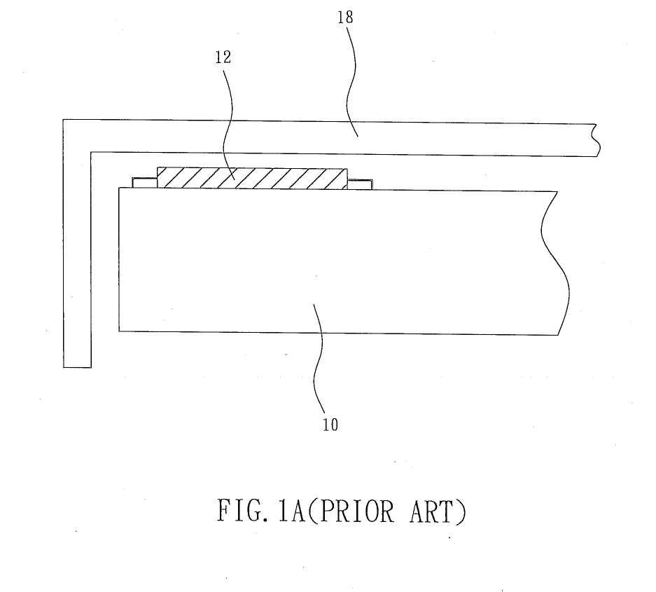

FIG. 1B is a partial cross-sectional view of a wireless communication electronic device showing another conventional planar inverted-F antenna disposed on a circuit board;

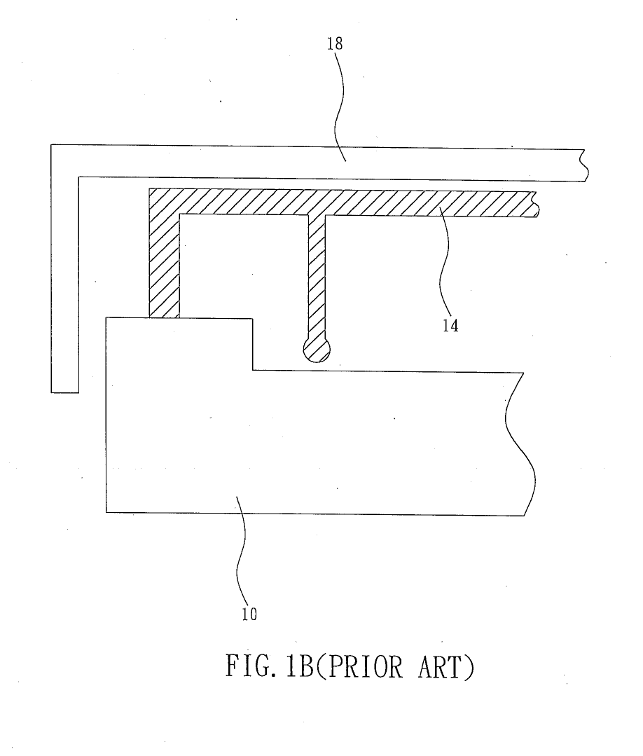

FIG. 1C is a partial cross-sectional view of a wireless communication electronic device showing a conventional flexible antenna disposed on a circuit board;

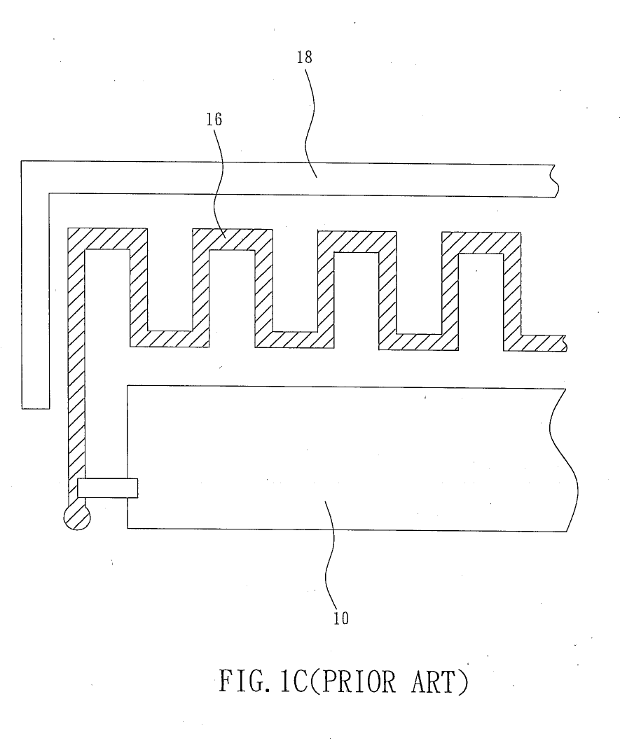

FIG. 2 is a partial cross-sectional illustration showing a wireless communication device according to a preferred embodiment of the invention; and

FIG. 3 is a partial cross-sectional illustration showing a wireless communication device according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

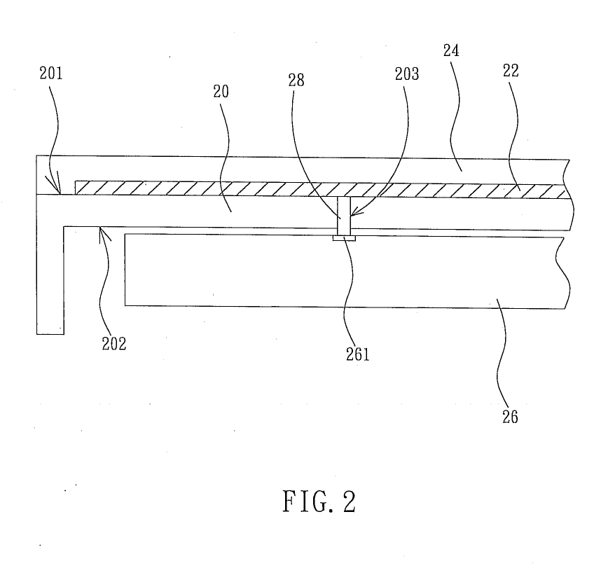

FIG. 2 is a partial cross-sectional illustration of a wireless communication device according to an embodiment of the invention. Referring to FIG. 2, the wireless communication device includes a housing 20, an antenna unit 22 and a protective layer 24. The antenna unit 22 is directly disposed on an outer surface 201 of the housing 20.

The antenna unit 22 can be electrically connected to a feeding point 261 on a circuit board 26 via a conductive wire. In the embodiment, a metal conductor 28 passes through a through hole 203 of the housing 20 to electrically connect to the feeding point 261 on the circuit board 26. The metal conductor 28 can be the above-mentioned conductive wire. The protective layer 24 covers the antenna unit 22 and at least a portion of the outer surface 201 of the housing 20. Because the protective layer 24 covers the antenna unit 22 completely, the antenna unit 22 is free from oxidation and damaging. The material of the protective layer 24 can be, for example but not limited to, a water-resistance, high-sealing, low-reactive or polymer material. The protective layer 24 can be formed by spray painting, baked-enamel coating, spin coating, coating or soaking. In the embodiment, the outer surface 201 of the housing 20 is, for example but not limited to, completely covered by the protective layer 24.

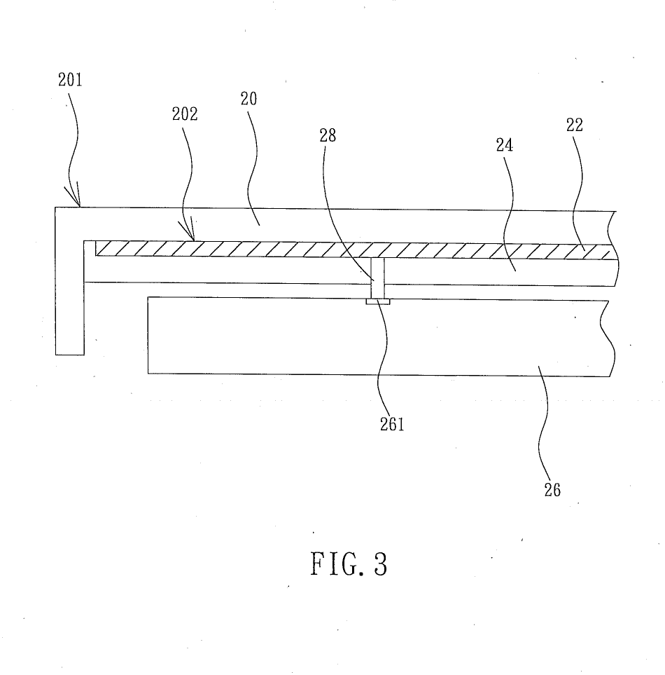

FIG. 3 is a partial cross-sectional illustration of a wireless communication device according to another embodiment of the invention. With reference to FIG. 3, the wireless communication device includes a housing 20 and an antenna unit 22. A circuit board 26 is disposed in the housing 20, and the antenna unit 22 is electrically connected to the circuit board 26 via a metal conductor 28. What is different from the previous embodiment is that the antenna unit 22 is disposed on the inner surface 202 of the housing 20 so that no hole is required for the metal conductor 28 to pass therethrough. Additionally, to avoid the interference among the antenna unit 22 and other electrical elements disposed on the circuit board 26, the outer surface of the antenna unit 22 is covered by a protective layer 24 for achieving isolation and protection.

As shown in FIG. 3, the protective layer 24 is disposed on the outer surface of the antenna unit 22. To be noted, since the antenna unit 22 is disposed inside the housing 20, the housing 20 can isolate the antenna unit 22 from outside, thereby protecting the antenna unit 22 from oxidation and damaging. Thus, based on different productions and specifications, the protective layer 24 can be selectively provided on the outer surface of the antenna unit 22 as it is disposed inside the housing 20.

In the embodiment, the wireless communication device can be a cellular phone, a personal digital assistant, a handheld PC, a global positioning system or a wireless earpiece. The antenna unit 22 can be a metallic painted antenna. The antenna unit 22 can be formed on the outer surface 201 or the inner surface 202 of the housing 20 by spray painting, baked-enamel coating, screen printing, coating, electroplating, evaporating, sputtering or the likes. Hence, an additional process of forming a metal-like-painted antenna as the antenna unit 22 on the outer surface 201 or the inner surface 202 of the housing 20 is performed before painting the housing 20. That is, the original manufacturing processes remain as usual.

Furthermore, the configuration of the antenna unit 22 can be designed according to various specifications. In one aspect, since the antenna unit 22 is disposed on the outer surface 201 of the housing 20, the transmitted signals do not have to pass through the housing 20. Consequently, the intensities of signals do not decay or be distorted. Therefore, the signal transmission performance of the wireless communication device can be enhanced.

Moreover, since the antenna unit 22 is disposed on the outer surface 201 or the inner surface 202 of the housing 20 instead of the circuit board 26, only a small area of the circuit board 26 is required to be preserved as a feeding point 261. This makes the layout region of the circuit board 26 as well as the size thereof be greatly reduced. Alternatively, if the size of the circuit board 26 remains the same, the circuit board 26 can provide more spaces for installing other electronic elements to improve the performance of the wireless communication device. Comparing to the conventional configuration having the antenna disposed on the circuit board, the antenna unit 22 of this invention can transmit signals without being blocked by the housing 20 and can alleviate the orientation problem during signal transmission. Thus, the configuration of this invention can greatly improve the performance of the wireless communication device.

In summary, since the antenna unit of the wireless communication device of the invention is disposed on the housing instead of the circuit board, the layout region used on the circuit board can be minimized. Thus, the wireless communication device can be minimized, or more additional electronic elements can be configured in the wireless communication device so as to improve the performance thereof. Comparing to the prior art, the configuration as well as the manufacturing processes of the wireless communication device remain as usual but the performance of transmitting signals can be enhanced via disposing the antenna unit on the housing. Furthermore, the manufacturing processes and the assemble procedures can be simplified so that the manufacturing time and cost can be reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless communication device comprising:
a housing; and
an antenna unit disposed on a surface of the housing.

2. The wireless communication device according to claim 1, wherein the surface is an inner surface of the housing.

3. The wireless communication device according to claim 1, wherein the surface is an outer surface of the housing.

4. The wireless communication device according to claim 1, further comprising a protective layer covering the antenna unit.

5. The wireless communication device according to claim 4, wherein the protective layer covers at least a portion of the surface.

6. The wireless communication device according to claim 4, wherein the protective layer is formed by spray painting, baked-enamel coating, spin coating, coating or soaking.

7. The wireless communication device according to claim 4, wherein the protective layer comprises a high-water-resistance, high-sealing material, low-reactive material or polymer material.

8. The wireless communication device according to claim 1, further comprising a circuit broad disposed inside the housing.

9. The wireless communication device according to claim 8, wherein the antenna unit is electrically connected to the circuit board.

10. The wireless communication device according to claim 9, wherein the antenna unit is electrically connected to the circuit board via a metal conductor or direct contact.

11. The wireless communication device according to claim 10, wherein the housing has a through hole, and the metal conductor passes through the through hole so as to electrically connect the circuit board and the antenna unit disposed on an outer surface of the housing.

12. The wireless communication device according to claim 10, wherein the metal conductor is a conductive wire.

13. The wireless communication device according to claim 1, wherein the antenna unit is a metallic painted antenna.

14. The wireless communication device according to claim 13, wherein the metallic painted antenna unit is formed by spray painting, baked-enamel coating, screen printing, coating, electroplating, evaporating or sputtering.

15. The wireless communication device according to claim 1, wherein the wireless communication device is a cellular phone, a personal digital assistant, a handheld PC, a global positioning system or a wireless earpiece.
